(19) United States
(12) Patent Application Publication
(10) Pub. No.: US 2024/0129303 A1
(43) Pub. Date: Apr. 18, 2024

(54) ROUTING DEVICE, MANAGEMENT CENTER DEVICE, USER AUTHENTICATION METHOD, AND STORAGE MEDIUM

(71) Applicant: DENSO CORPORATION, Kariya-city (JP)

(72) Inventors: Masatoshi KOMIYAMA, Kariya-city (JP); Kensho Taki, Kariya-city (JP); Lingfei Xie, Kariya-city (JP); Shigeru Kajioka, Kariya-city (JP); Makiko Tauchi, Kariya-city (JP)

(21) Appl. No.: 18/396,632

(22) Filed: Dec. 26, 2023

Related U.S. Application Data
(63) Continuation of application No. PCT/JP22/24916, filed on Jun. 22, 2022.

(30) Foreign Application Priority Data
Jul. 2, 2021 (JP) 2021-110908

(51) Int. Cl. H04L 9/40

(52) U.S. Cl. CPC H04L 63/0853

(57) ABSTRACT

A routing device communicable with a first center device and a second center device related to providing a service to a first vehicle linked with a first user and a second vehicle linked with a second user is provided. The routing device is configured to store first linking information that links a first attribute and a first user belonging to the first attribute, and second linking information that links a second attribute and a second user belonging to the second attribute, acquire the second attribute corresponding to the second user, and request the second center device corresponding to the second attribute to perform an authentication process of the second user.

### CROSS REFERENCE TO RELATED APPLICATION

The present application is a continuation application of International Patent Application No. PCT/JP2022/024916 filed on Jun. 22, 2022 which designated the U.S. and claims the benefit of priority from Japanese Patent Application No. 2021-110908 filed on Jul. 2, 2021. The entire disclosures of all of the above applications are incorporated herein by reference.

### TECHNICAL FIELD

The present disclosure relates to user authentication technology.

### BACKGROUND

The authentication system described in a relevant art includes a user terminal, an authentication server connected to the user terminal, and a plurality of service provider systems connected to the authentication server, wherein, depending on characteristics of personal information, it may not be possible to centrally manage the personal information used in multiple services with one server device.

### SUMMARY

According to one example, a routing device communicable with a first center device and a second center device related to providing a service to a first vehicle linked with a first user and a second vehicle linked with a second user is provided. The routing device is configured to store first linking information that links a first attribute and a first user belonging to the first attribute, and second linking information that links a second attribute and a second user belonging to the second attribute, acquire the second attribute corresponding to the second user, and request the second center device corresponding to the second attribute to perform an authentication process of the second user.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a configuration of a mobility IoT system according to a first embodiment;

FIG. 2 is a diagram of a structure of standardized vehicle data according to the first embodiment;

FIG. 3 is a block diagram of a configuration of a management center according to the first embodiment;

FIG. 4 is a block diagram of a configuration of a routing device according to the first embodiment;

FIG. 5 is a block diagram of a functional configuration of a management center according to the first embodiment;

FIG. 6 is a sequence diagram showing a procedure of a user authentication process according to the first embodiment;

FIG. 7 is a diagram of data stored in a region determination DB according to the first embodiment;

FIG. 8 is a diagram of data stored in a URL DB according to the first embodiment;

FIG. 9 is a block diagram of another example of the configuration of the management center according to the first embodiment; and

FIG. 10 is a sequence diagram showing a procedure of a user authentication process according to a second embodiment.

### DETAILED DESCRIPTION

The authentication system described in a relevant art includes a user terminal, an authentication server connected to the user terminal, and a plurality of service provider systems connected to the authentication server. The authentication server centrally manages users' personal information and centrally authenticates users when they log in to online services of each service provider system.

As a result of detailed study by the inventor, the problem was discovered that, depending on the characteristics of personal information, it may not be possible to centrally manage personal information used in multiple services with one server device.

In one aspect, when a user uses data from a center device that does not manage the relevant user's personal information, it may be desirable to authenticate such user.

A routing device according to one aspect of the present disclosure is capable of communicating with a first center device and a second center device related to providing a service to a first vehicle linked with a first user and a second vehicle linked with a second user, and includes a storage unit and a routing control unit. The storage unit is configured to store (a) first linking information that links a first attribute and a first user belonging to the first attribute, and (b) second linking information that links a second attribute and a second user belonging to the second attribute. The routing control unit is, in response to receiving authentication information of the second user from the first center device corresponding to the first attribute, configured to (i) acquire the second attribute corresponding to the second user from the storage unit, and (ii) request the second center device corresponding to the second attribute to perform an authentication process of the second user.

The above-described routing device, in response to receiving the authentication information of the second user from the first center device, acquires the second attribute corresponding to the second user from the storage unit, and requests the second center device corresponds to the second attribute for the authentication process of the second user. Therefore, the second user, when using a service based on data of the first center device that does not correspond to the second attribute, is authenticated by the second center device that corresponds to the second attribute, for using such service.

A user authentication method according to another aspect of the present disclosure includes a step for acquiring, from a table that defines (a) first linking information that links a first attribute and a first user belonging to the first attribute, and (b) second linking information that links a second attribute and a second user belonging to the second attribute, the second attribute corresponding to the second user, in response to receiving authentication information of the second user from a first center device corresponding to the first attribute. Further, the above-described authentication method includes a step for requesting the second center device corresponding to the acquired second attribute to perform an authentication process of the second user.

According to the above-described user authentication method, the same effects as the above-described routing device are achievable.

A user authentication program according to yet another aspect of the present disclosure causes, in response to receiving authentication information of a second user from a first center device corresponding to a first attribute, a routing device that is capable of communicating with the first center device and a second center device, to (i) acquire, from a table that defines (a) first linking information that links the first attribute and a first user belonging to the first attribute, and (b) second linking information that links a second attribute and a second user belonging to the second attribute, and (ii) request the second center device corresponding to the acquired second attribute to perform an authentication process of the second user.

By executing the above-described user authentication program, the same effects as those of the above-described routing device are achievable.

A management center device according to still yet another aspect of the present disclosure is used in a system including a first center device, a second center device, and a routing device. The management center device includes the first center device. The first center device is configured to manage authentication information of a first user belonging to a first attribute. The second center device is configured to manage authentication information of a second user belonging to a second attribute. The routing device is configured to (i) include a storage unit that stores (a) first linking information that links a first attribute and a first user, and (b) second linking information that links a second attribute and a second user, (ii) acquire, in response to receiving the second user's authentication information from a first center device, the second attribute corresponding to the second user from the second linking information, and (iii) transmit information regarding the acquired second attribute to the first center device. The first center device is configured to request the second center device to perform an authentication process of the second user, in response to receiving information regarding the second attribute from the routing device.

Upon receiving the second user's authentication information, the management center device transmits the second user's authentication information to the routing device, and receives information regarding the second attribute corresponding to the second user from the routing device. Then, the management center device requests the second center device corresponding to the second attribute to perform the authentication process of the second user. That is, when the management center device receives the authentication information of a user other than a management target user, the management center device requests another center device that manages the authentication information of the relevant user for the authentication process of such user. Therefore, the second user, when using a service based on data of the first center device that does not correspond to the second attribute, is authenticated by the second center device that corresponds to the second attribute, for using such service.

Hereinafter, exemplary embodiments for implementing the present disclosure will be described with reference to the drawings.

### 1. FIRST EMBODIMENT

### <1-1. Configuration>

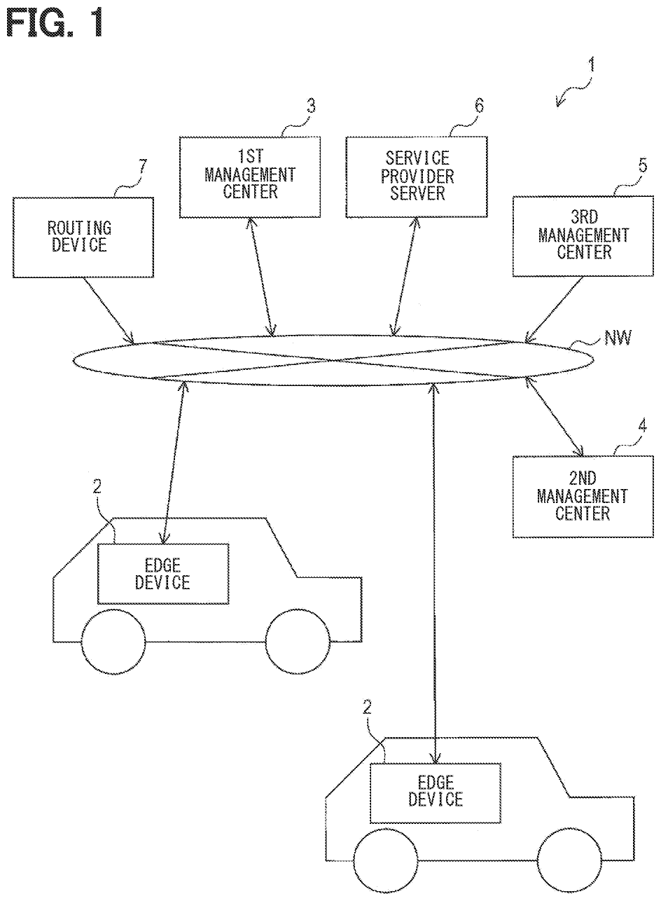

The configuration of a mobility Internet of Things system 1 (hereinafter referred to as IoT) according to the present embodiment will be described with reference to FIG. 1. The mobility IoT system 1 includes a plurality of edge devices 2, a first management center 3, a second management center 4, a third management center 5, a service provider server 6, and a routing device 7. In the present embodiment, the mobility IoT system 1 includes the first management center 3, the second management center 4, and the third management center 5. However, the third management center 5 may be excluded from the mobility IoT system 1. Alternatively, the mobility IoT system 1 may include one or more management centers in addition to the first management center 3, the second management center 4, and the third management center 5.

The edge device 2 is mounted on a vehicle. The edge device 2 collects various types of vehicle data, normalizes and converts the collected vehicle data into a standard format, and creates a data structure. By normalizing the vehicle data, the same physical quantity is converted into vehicle data that indicates the same value regardless of the vehicle type and vehicle manufacturer.

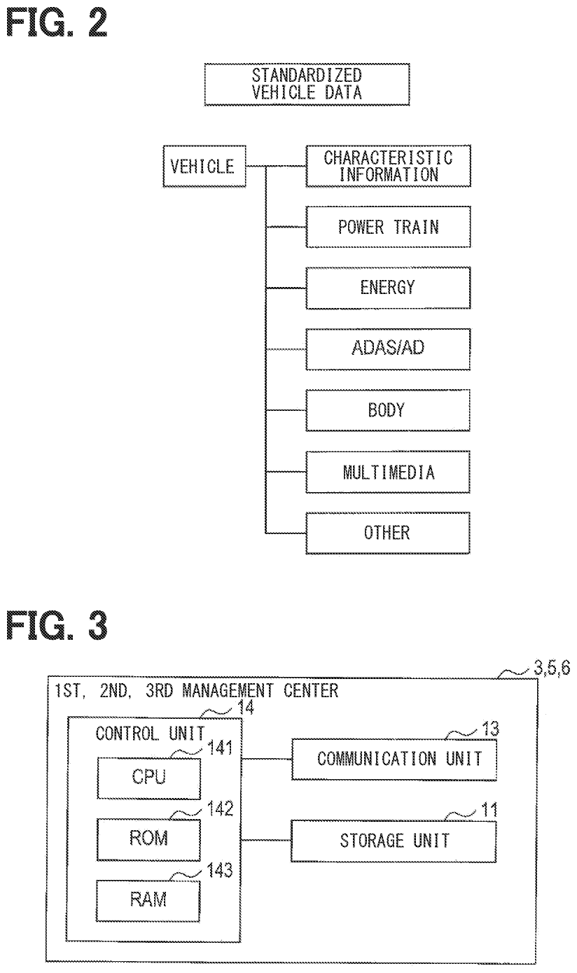

Further, the edge device 2 generates standardized vehicle data. The standardized vehicle data is generated for each vehicle (that is, for each edge device 2) and has a multi-layer structure. For example, as shown in FIG. 2, the standardized vehicle data includes, as items set in a first layer at the top: “Attribute information,” “Powertrain,” “Energy,” and “Advanced Driver Assistance System (ADAS)/Autonomous Driving (AD),” “Body,” “Multimedia,” and “Others.” Data related to each item is stored in the lower layers of each item. The data converted to the standard format is stored in the bottom layer of the “attribute information” item.

The edge device 2 performs data communication with any of the first to third management centers 3 to 5 via a wide area wireless communication network NW. The edge device 2 uploads the generated standardized vehicle data to any of the first to third management centers 3 to 5 via a communication device (not shown).

The service provider server 6 uses data from any of the first to third management centers 3 to 5 to provide services to users. For example, the service provider server 6 provides a service for managing vehicle operation to the user via the edge device 2. Note that the mobility IoT system 1 may include a plurality of service provider servers 6, and the plurality of service provider servers 6 may provide respectively different services using data from any one of the first to third management centers 3 to 5.

The first to third management centers 3 to 5 manage the mobility IoT system 1. The first to third management centers 3 to 5 share standardized vehicle data through replication or the like. The first to third management centers 3 to 5 perform data communication with a plurality of edge devices 2, service provider servers 6, and routing devices 7 via the wide area wireless communication network NW. Further, the first to third management centers 3 to 5 perform data communication with each other via the wide area wireless communication network NW.

The first to third management centers 3 to 5 correspond to different attributes. That is, different attributes are assigned to the first to third management centers 3 to 5. The first management center 3 corresponds to a first attribute, and manages personal information of a first user registered for the first attribute. The second management center 4 corresponds to a second attribute, and manages personal information of a second user registered for the second attribute. The third management center 5 corresponds to a third attribute, and manages personal information of a third user registered for the third attribute. Personal information includes the user's name, address, telephone number, vehicle registration number, etc., as well as authentication information used for user authentication. The authentication information is, for example, a user service ID and a password.

Due to personal information protection rules applied according to attributes, the first to third management centers 3 to 5 do not manage the personal information of users registered for attributes that they do not support. That is, the first to third management centers 3 to 5 do not share the personal information that they manage. The second and third management centers 4 and 5 do not manage the first user's personal information. Further, the first and third management centers 3 and 5 do not manage the second user's personal information. The first and second management centers 3 and 4 do not manage the third user's personal information. The first to third management centers 3 to 5 share, with each other, information that is not subject to personal information protection.

Attributes include, for example, region and country. In the present embodiment, the first attribute corresponds to a first region to which the first user belongs (specifically, a region to which the personal information is registered), and the second attribute corresponds to a second region to which the second user belongs, and the third attribute corresponds to a third region to which the third user belongs. Each of the countries and regions has its own rules for protecting the personal information, and the first to third management centers 3 to 5 must comply with the rules of the corresponding region. Among the rules for protecting the personal information, there are also rules that restrict the personal information of users belonging to a predetermined region from being taken out of the predetermined region. In the present embodiment, it is assumed that each of the first region, the second region, and the third region has rules that restrict taking personal information of users belonging to each region out of the relevant region. Further, the attribute may be, for example, an organization such as a company, a school, or a club team.

The service provider server 6 uses data in a management center, not corresponding to the attributes registered by the user, but corresponding to the attributes at the time of using a service (for example, a region where the user is currently located). For example, when the first user, the second user, and the third user use the service provided by the service provider server 6 in the first region, the service provider server 6 uses the data of the first management center 3. That is, even in a situation that the first user's personal information is registered in the first management center 3, the second user's personal information is registered in the second management center 4, and the third user's personal information is registered in the third management center 5, the service provider server 6 uses the data of the first management center 3 in order to provide services to the first user, the second user, and the third user.

As shown in FIG. 3, the first to third management centers 3 to 5 include a control unit 14, a communication unit 13, and a storage unit 11.

The control unit 14 is an electronic control device in the form of a microcomputer including a CPU 141, a ROM 142, and a RAM 143. Various functions of the first to third management centers 3 to 5 are realized by the CPU 141 executing programs stored in a non-transitory, substantial recording medium. In the present embodiment, the ROM 142 corresponds to a non-transitory, substantial recording medium that stores a program. Further, a method corresponding to the program is performed by executing such program. Note that some or all of the functions performed by the CPU 141 may be configured as hardware using one or more ICs or the like. Further, the number of microcomputers configuring the control unit 14 may be one or more than one.

The communication unit 13 performs data communication with the plurality of edge devices 2, the service provider server 6, the routing device 7, and other management centers via the wide area wireless communication network NW. The storage unit 11 is a storage device that stores various data.

The routing device 7 stores linking information that links each attribute with a user belonging to each attribute. The routing device 7 stores information which is not restricted in terms of deportation thereof to the foreign country or the like, that is, information that is not subject to personal information protection. For example, a service user ID for identifying a user and a code indicating an attribute are stored in linking with each other.

Specifically, the routing device 7 stores first linking information, second linking information, and third linking information. The first linking information links or links the first attribute and the first user belonging to the first attribute. The second linking information links or links the second attribute and the second user belonging to the second attribute. The third linking information links or links the third attribute and the third user belonging to the third attribute. For example, a service user ID=0001 is linked with a region code X, and a service user ID=0002 is linked with a region code Y. For example, a list of service user IDs belonging to the region code X corresponds to the first linking information, a list of service user IDs belonging to the region code Y corresponds to the second linking information, and a list of service user IDs belonging to a region code Z corresponds to the third linking information. Note that the routing device 7 may store the first to third linking information collectively. That is, the routing device 7 may store a list that links service user IDs and region codes.

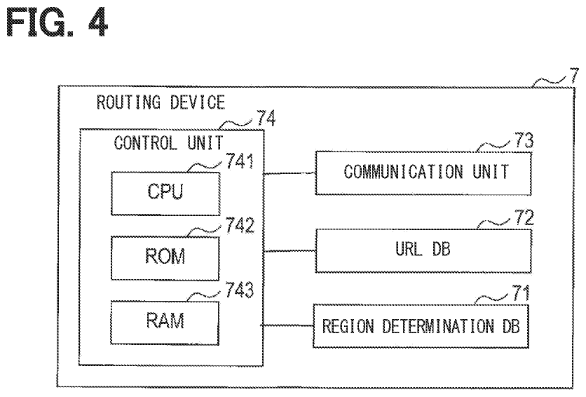

As shown in FIG. 4, the routing device 7 includes a control unit 74, a communication unit 73, a URL DB 72, and a region determination DB 71.

The control unit 74 is an electronic control device in the form of a microcomputer including a CPU 741, a ROM 742, and a RAM 743. Various functions of the routing device 7 are realized by the CPU 741 executing programs stored in a non-transitory, substantial recording medium. In the present embodiment, the ROM 742 corresponds to a non-transitory, substantial recording medium that stores a program. Further, a method corresponding to the program is performed by executing such program. Note that part or all of the functions performed by the CPU 741 may be configured as hardware using one or more ICs or the like. Furthermore, the number of microcomputers configuring the control unit 74 may be one or more than one.

The communication unit 73 performs data communication between the first to third management centers 3 to 5 via the wide area wireless communication network NW.

The region determination DB 71 stores an attribute (specifically, a registered region) and a service user ID of a user registered for the attribute in linking with each other. Specifically, the region determination DB 71 stores the first linking information, the second linking information, and the third linking information mentioned above. The region determination DB 71 may also be referred to as an attribute determination DB. The URL DB 72 stores attributes and management centers corresponding to the attributes (specifically, a URL of the management center) in linking with each other. Individual URLs are assigned to the first to third management centers 3 to 5, respectively. Such a URL is a URL for data communication with each of the first to third management centers 3 to 5.

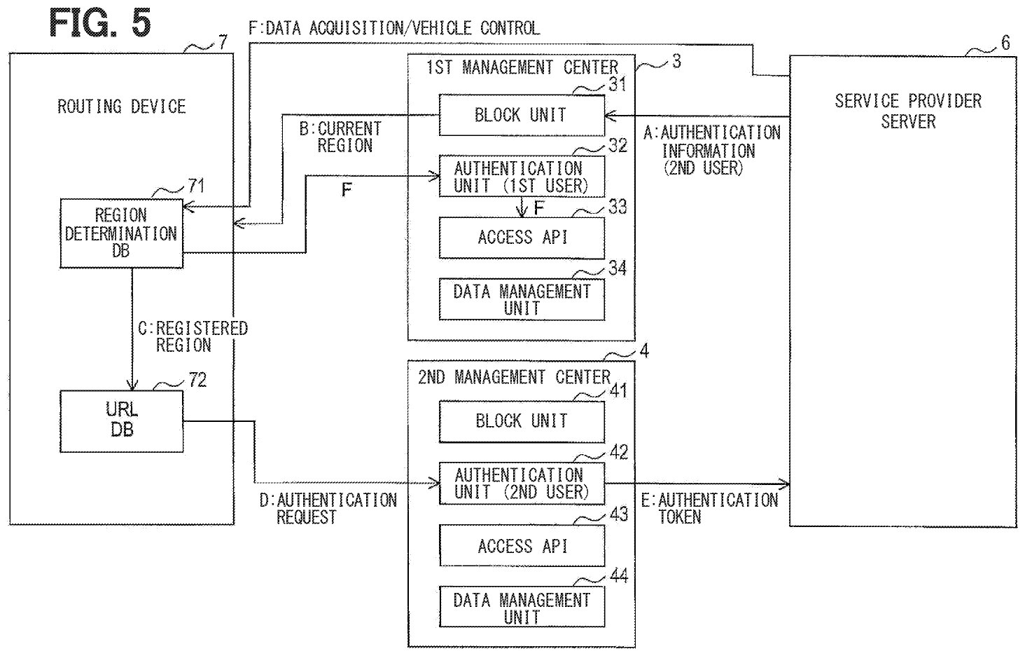

FIG. 5 shows the functions realized by the first management center 3 and the second management center 4. The first and second management centers 3 and 4 have the functions of block units 31 and 41, authentication units 32 and 42, access application programming interfaces (API) 33 and 43, and data management units 34 and 44.

The data management units 34 and 44 manage the uploaded standardized vehicle data. For example, the first management center 3 installed in the first region manages the standardized data uploaded from vehicles currently in the first region, and the second management center 4 installed in the second region manages the standardized data uploaded from vehicles currently in the second region.

The access APIs 33 and 43 are standard interfaces for the service provider server 6 to access the data management units 34 and 44.

The block units 31 and 41 restrict access to data managed by the data management units 34 and 44 for each service. That is, the block units 31 and 41 request authentication of a user who uses data managed by the data management units 34 and 44 for each service.

The authentication units 32 and 42 authenticate users who are qualified to use the data managed by the data management units 34 and 44 via the service provider server 6.

### <1-2. Processing>

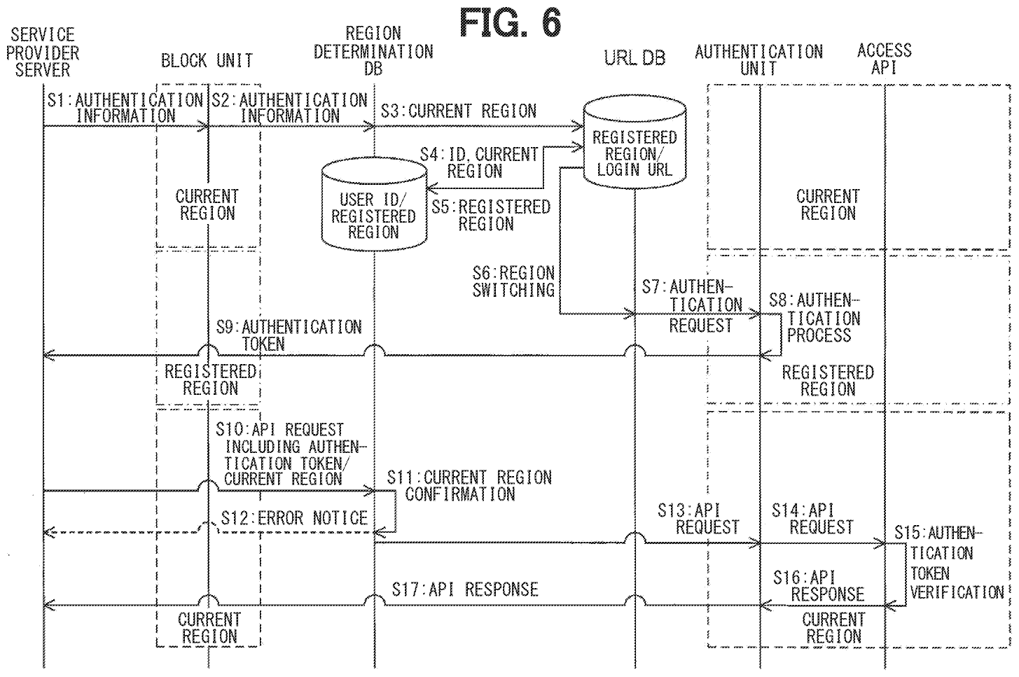

Next, user authentication when the second user uses the service of the service provider server 6 in the first region according to the first embodiment will be described with reference to FIGS. 5 and 6. That is, a description will be given of the user authentication when the second user having the attribute of the second region is currently in the first region and receives a service. The service provider server 6 acquires the second user's current location through communication with a mobile terminal or the like owned by the second user, and learns that the second user is in the first region. In the first region, the service provider server 6 accesses data of the first management center 3 provided in the first region. The first management center 3 requests for authentication of the second user, but cannot perform the authentication process of the second user by itself because it does not manage the authentication information of the second user. If the second user is not authenticated, the service provider server 6 cannot provide the second user with a service using the data of the first management center 3.

Therefore, the routing device 7 requests the second management center 4 located in the second region, which manages the second user's authentication information, to perform authentication process of the second user. Such a user authentication process occurs when, for example, the second user residing in the second region moves to the first region and rents a rental car, and uses, in the first region, the same service of the service provider server 6 he/she has been using in the second region.

In S1, the service provider server 6 transmits the second user's authentication information to the block unit 31. The authentication information includes a service user ID and a password.

In S2, the block unit 31 transmits the authentication information to the routing device 7.

In S3, the routing device 7 transmits the second user's current region (that is, the first region where the first management center 3 is located) and the authentication information to the URL DB 72.

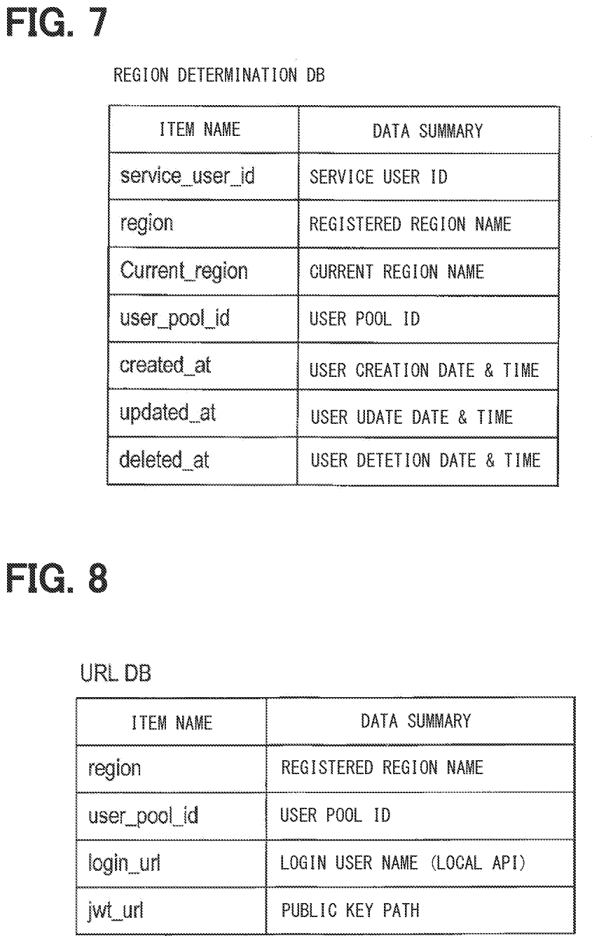

In S4, the routing device 7 transmits the current region and the authentication information from the URL DB 72 to the region determination DB 71, and stores the current region in the region determination DB 71. As shown in FIG. 7, the region determination DB 71 stores a service user ID, a registered region name, and a current region name in linking with each other.

In S5, the routing device 7 acquires the registered region name (that is, the second region which is an attribute) linked to the service user ID from the region determination DB 71, and acquires a login URL (that is, a URL of the second management center 4) linked to the registered region name from the URL DB 72. As shown in FIG. 8, a registered region name and a login URL are stored in a linked manner in the URL DB 72.

In S6, the routing device 7 switches a destination to which the authentication process is requested to the acquired login URL.

In S7, the routing device 7 transmits the second user's authentication information to the switched login URL, and requests for the second user's authentication process. That is, the routing device 7 requests the second management center 4 to perform an authentication process of the second user.

In S8, the authentication unit 42 of the second management center 4 receives the second user's authentication request, and performs an authentication process of the second user.

Subsequently, in S9, the authentication unit 42 transmits an authentication token to the service provider server 6 when the second user is successfully authenticated. By transmitting the URL of the service provider server 6 along with the second user's authentication information, the authentication token can be transmitted to the service provider server 6.

In S10, in response to receiving the authentication token, the service provider server 6 transmits to the routing device 7, an API request including the authentication token and the current region. The API request is, for example, a vehicle data acquisition request, a vehicle control request, or the like.

In S11, the routing device 7 confirms whether the current region received from the service provider server 6 matches the current region stored in the region determination DB 71 in S4. When the current regions do not match, an error notice is transmitted to the service provider server 6 in S12. When the second user moves across regions between time of S4 and time of S10, a current region mismatch occurs.

When the current regions match, the routing device 7 transmits the API request with the authentication token to the authentication unit 42 of the second management center 4 in S13.

In S14, the authentication unit 42 transmits the API request with the authentication token to an access API 43.

In S15, the access API 43 verifies whether the authentication token is valid.

In S16, the access API 43 transmits an API response to the authentication unit 42 when the authentication token is valid.

In S17, the authentication unit 42 transmits the API response to the service provider server 6. In such manner, the second user can, or is enabled to, use the service of the service provider server 6.

Note that when the first user uses the service of the service provider server 6 in the first region, the routing device 7 acquires the login URL of the first management center 3, and requests the first management center 3 for an authentication process of the first user. The first management center 3 may perform an authentication process of the first user in the authentication unit 32 without requesting the routing device 7 for authentication. Further, when the first user uses the service of the service provider server 6 in the second region, the routing device 7 acquires the login URL of the first management center 3 based on a request from the second management center 4, and requests the first management center 3 to authenticate the first user.

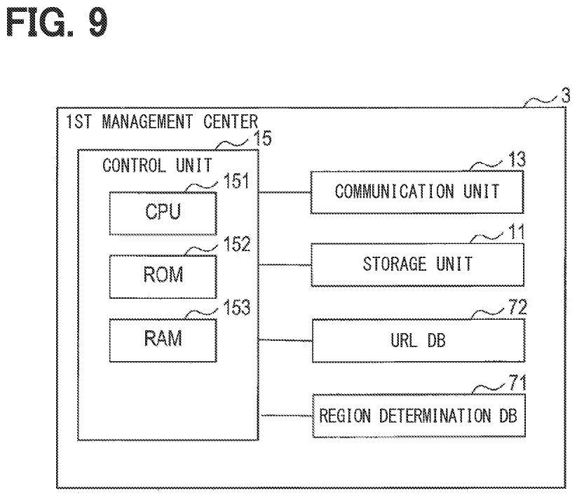

Though the routing device 7 has been described as a separate device from the first to third management centers 3 to 5 so far, the routing device 7 may also be included in any one of the first to third management centers 3 to 5. FIG. 9 shows an example in which the first management center 3 includes the routing device 7. The first management center 3 includes the URL DB 72 and the region determination DB 71 in addition to the control unit 15, the communication unit 13, and the storage unit 11. The control unit 15 includes a CPU 151, a ROM 152, and a RAM 153, and realizes the functions implemented by the control unit 74 in addition to the functions implemented by the control unit 14. By providing the routing device 7 in any of the first to third management centers 3 to 5, the mobility IoT system 1 is simplified for the cost reduction.

### <1-3. Effects>

According to the first embodiment described above in details, the following effects are achievable.

(1) In response to receiving the second user's authentication information from the first management center 3, the routing device 7 acquires the second region, which is the registered region of the second user, from the region determination DB 71, and requests the second management center 4 corresponding to the second user to perform the authentication process of the second user. Therefore, the second user, by the user authentication performed by the second management center 4, is enabled to use the service based on the data of the first management center 3, which does not have the second user's authentication information.

(2) When the second user belonging to the second region moves to the first region, he or she is enabled to use the same service as the one having used in the first region.

### 2. SECOND EMBODIMENT

<2-1. Differences from First Embodiment>

A basic configuration of the second embodiment is similar to that of the first embodiment, and therefore, differences from the first embodiment will be described in the following. The same reference numerals as in the first embodiment denote the same configurations, and reference is made to the preceding description.

In the first embodiment described above, the routing device 7 acquires the login URL of the second management center 4, and requests the second management center 4 to authenticate the second user. In contrast, the second embodiment differs from the first embodiment in that the routing device 7 acquires the login URL of the second management center 4, and transmits the acquired login URL to the first management center 3.

### <2-2. Processing>

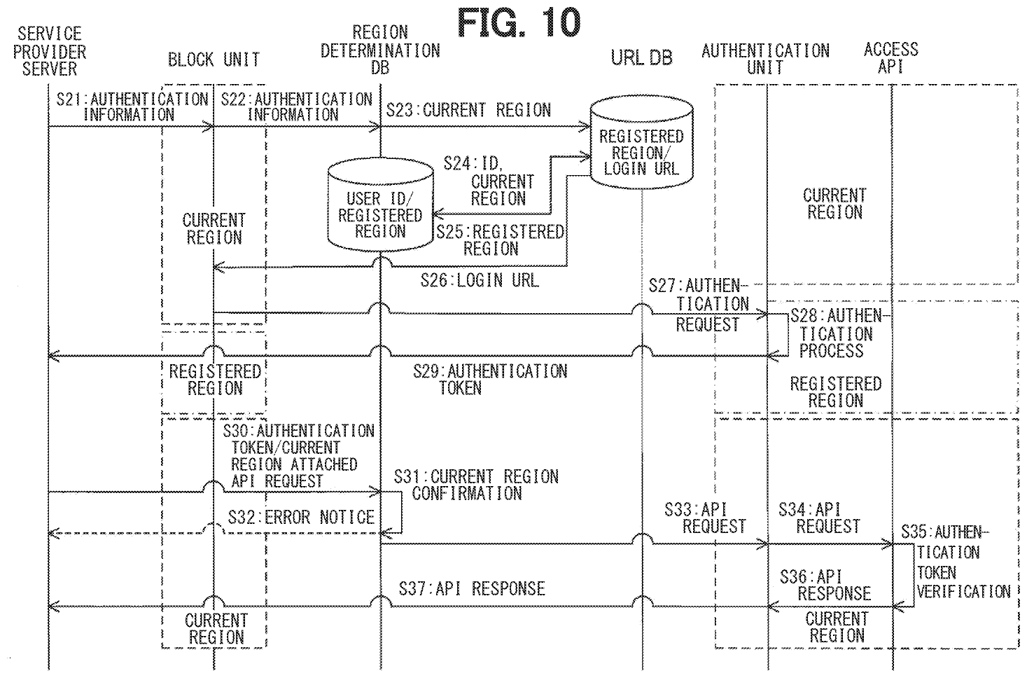

Next, user authentication when the second user uses the service of the service provider server 6 in the first region according to the second embodiment will be described with reference to FIG. 10.

In S21 to S25, the first management center 3 and the routing device 7 perform the same processes as in S1 to S5.

In S26, the routing device 7 transmits the acquired login URL to the first management center 3.

In S27, the first management center 3 transmits the second user's authentication information to the received login URL, and requests for the authentication process of the second user. That is, the first management center 3 requests the second management center 4 to perform an authentication process of the second user.

In S28 to S37, the second management center 4, the service provider server 6, and the routing device 7 perform the same processes as in S8 to S17.

Note that, when the first user uses the service of the service provider server 6 in the second region, the second management center 4 requests the first management center 3 to authenticate the first user. The first management center 3 performs the authentication process of the first user in response to the request from the second management center 4 to authenticate the first user.

Further, similar to the first embodiment, the routing device 7 may be included in any of the first to third management centers 3 to 5.

### <2-3. Effects>

According to the second embodiment described above in details, the effect (2) of the first embodiment described above is achievable, as well as the following effects.

(3) Upon receiving the second user's authentication information, the first management center 3 transmits the second user's authentication information to the routing device 7, and receives the second user's registered region from the routing device 7. Then, the first management center 3 requests the second management center 4 corresponding to the second region to perform the authentication process of the second user. That is, when the first management center 3 receives the authentication information of a user other than the management target user, the first management center 3 requests the second management center 4 managing the authentication information of such user for an authentication process thereof. Therefore, the second user, when attempting to use the service based on the data of the first management center 3, which does not have the second user's authentication information, is enabled to undergo the user authentication by the second management center 4.

### 3. OTHER EMBODIMENTS

Although the embodiments of the present disclosure have been described above, the present disclosure is not limited to the embodiments described above, and various modifications can be made to implement the present disclosure.

(a) In the above embodiments, the attribute is considered as a region. However, the attribute is not limited to a region. The attribute may be, for example, an age, a gender, an occupation, presence or absence of a predetermined qualification, and the like.

(b) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. A part of the configuration of the above embodiments may be omitted as appropriate. Further, at least a part of the configuration of the above-described embodiments may be added to or replaced with the configuration of another embodiment described above.

(c) In addition to the above-mentioned routing device and management center, the present disclosure can also be implemented in various forms, such as a system comprising a routing device and two or more management centers, a program for causing a computer to function as a routing device or a management center, a non-transitory, substantial recording media such as a semiconductor memory or the like storing such a program, and the like.

What is claimed is:

1. A routing device capable of communicating with a first center device and a second center device related to providing a service to a first vehicle linked with a first user and a second vehicle linked with a second user, the routing device comprising:
a storage unit configured to store first linking information that links a first attribute and a first user belonging to the first attribute, and second linking information that links a second attribute and a second user belonging to the second attribute; and
a routing control unit configured to, in response to receiving authentication information of the second user from the first center device corresponding to the first attribute, acquire the second attribute corresponding to the second user from the storage unit and request the second center device corresponding to the second attribute to perform an authentication process of the second user.

2. The routing device of claim 1, wherein
in response to receiving the authentication information of the first user from the first center device corresponding to the first attribute, the routing control unit acquires the first attribute corresponding to the first user from the storage unit, and requests the first center device corresponding to the first attribute to perform the authentication process of the first user. device.

3. The routing device of claim 1, wherein
the routing device is included in the first center device or the second center

4. The routing device of claim 1, wherein
the first attribute includes a first region to which the first user belongs,
the second attribute includes a second region to which the second user belongs, and
the routing control unit is configured to, in response to receiving the authentication information of the second user from the first center device installed in the first region, acquire the second region corresponding the second user from the storage unit, and request the second center device installed in the second region to perform the authentication process of the second user.

5. A management center device including the second center device according to claim 1, the management center device comprising:
an authentication unit configured to
manage the authentication information of the second user, and
perform an authentication process of the second user in response to receiving a request to perform the authentication process of the second user

6. A user authentication method comprising steps of:
acquiring second attribute corresponding to a second user from a table that defines first linking information that links a first attribute and a first user belonging to the first attribute and second linking information that links a second attribute and a second user belonging to the second attribute, in response to receiving authentication information of the second user from a first center device corresponding to the first attribute; and
requesting a second center device corresponding to the received second attribute to perform an authentication process of the second user.

7. A computer readable non-transitory storage medium storing a user authentication program including instructions for causing a computer to serve as a routing device capable of communicating with a first center device and a second center device, the routing device caused to perform steps of:
acquiring second attribute corresponding to a second user from a table that defines first linking information that links a first attribute and a first user belonging to the first attribute, and second linking information that links a second attribute and a second user belonging to the second attribute, the second attribute corresponding to the second user, in response to receiving authentication information of the second user from a first center device corresponding to the first attribute; and
requesting a second center device corresponding to the received second attribute to perform an authentication process of the second user.

8. A management center device used in a system equipped with a first center device, a second center device and a routing device, the management center device comprising:
the first center device,
wherein
the first center device is configured to manage authentication information of a first user belonging to a first attribute,
the second center device is configured to manage authentication information of a second user belonging to a second attribute,
the routing device is configured to
store first linking information that links the first attribute and the first user, and second linking information that links the second attribute and the second user,
acquire, in response to receiving the authentication information of the second user from the first center device, the second attribute corresponding to the second user from the second linking information, and
transmit information regarding the acquired second attribute to the first center device,
the first center device is configured to request the second center device to perform an authentication process of the second user, in response to receiving information regarding the second attribute from the routing device.

9. The management center device of claim 8, wherein
the first center device is configured to perform the authentication process of the first user in response to a request for authentication process of the first user from the second center device.

10. The management center device of claim 8, wherein
the management center device includes the routing device.

11. The management center device of claim 8, wherein
the first attribute includes a first region to which the first user belongs,
the second attribute includes a second region to which the second user belongs, and
the routing device is configured to, in response to receiving the authentication information of the second user from the first center device installed in the first region, acquire the second region corresponding the second user from the second linking information and request the second center device installed in the second region to perform the authentication process of the second user.
